(19) United States
(12) Patent Application Publication
(10) Pub. No.: US 2025/0289182 A1
(43) Pub. Date: Sep. 18, 2025

(54) PRINTHEAD FOR A FILAMENT 3D PRINTER, A 3D PRINTER INCLUDING SUCH A PRINT HEAD AND A METHOD FOR PRODUCING A 3D PRINTED POLYMER COMPOSITE

(71) Applicant: KING ABDULLAH UNIVERSITY OF SCIENCE AND TECHNOLOGY, Thuwal (SA)

(72) Inventors: Yahya KARA, Thuwal (SA); Norbert Krisztián KOVÁCS, Thököl (HU); Kolos MOLNÁR, Budapest (HU)

(21) Appl. No.: 18/863,371

(22) PCT Filed: May 8, 2023
(86) PCT No.: PCT/IB2023/054768

§ 371 Date: Nov. 6, 2024

(30) Foreign Application Priority Data
May 9, 2022 (HU) P2200146

(51) Int. Cl. B29C 64/321; B29C 48/00; B29C 48/02; B29C 48/30; B29C 48/86; B29C 64/118; B29C 64/209; B29C 64/295; B29K 67/00; B33Y 10/00; B33Y 30/00; B33Y 40/00

(52) U.S. Cl. CPC B29C 64/321; B29C 48/0018; B29C 48/02; B29C 48/30; B29C 48/865; B29C 64/118; B29C 64/209; B29C 64/295; B33Y 10/00; B33Y 30/00; B33Y 40/00; B29K 2067/046

(57) ABSTRACT

A print head for a filament 3D printer includes a channel for guiding a polymer filament through an outlet opening, a heating block in contact with the outlet opening of the channel and configured to heat the polymer filament, a nozzle having an outlet aperture, where the nozzle is connected to the outlet opening of the channel so that the polymer filament passes through the outlet aperture, and the outlet aperture of the nozzle is arranged axisymmetrically around the nozzle and located on a longitudinal axis (T) of the nozzle, and one or more air outlet openings directed towards a meeting zone (P) defined by tips of the air outlet openings and the outlet aperture of the nozzle.

### BACKGROUND OF THE INVENTION

### Technical Field

The subject of one embodiment of the invention is a print head for a 3-dimensional printer using filaments. The print head includes a channel for guiding a polymer print filament, a heating element in contact with the channel, and a nozzle at an outlet opening of the channel, which has a nozzle outlet aperture. Another embodiment of the invention includes a filament 3D printer, which uses a print head according to the embodiment of the invention discussed above. The subject of still another embodiment of the invention is a method for producing a 3D-printed polymer composite using the print head according to the embodiment of the invention discussed above.

### Discussion of the Background

3-dimensional (3D) printing is one of the revolutionary technologies of recent decades, which may transform the structure of industry in the near future (fourth industrial revolution). 3-dimensional printing is a so-called additive manufacturing process (Additive Manufacturing: AM), i.e., the objects are made by laying down layers applied on top of each other, as opposed to traditional processes, during which the excess material is taken off one or more larger pieces and the remaining part becomes the finished product. With the help of 3-dimensional printing, it is also possible to create complex shapes and small-series parts (e.g., prototypes) that cannot be produced or economically produced with the use of traditional machining methods.

In recent times, there has been much development, mainly in the 3-dimensional printing of plastics. Currently, there are several technologies that differ fundamentally in how each layer is built on top of the other. In the case of plastics, one of the most common methods is the so-called Fused Filament Fabrication (FFF). During this process, a hot print head moves horizontally over the printing surface and a feeding mechanism draws a plastic filament (so-called printer filament) from a roll into the head, where it melts and reaches the print bed through a nozzle. This process is repeated until all layers are printed. Materials for printing filament range from bioplastics such as polylactic acid (PLA) to engineering polymers such as polycarbonate (PC), acrylonitrile butadiene styrene (ABS) and polyamide (PA).

In the case of FFF-printed parts, one of the biggest challenges is to increase the strength of the bonds between the individual layers to improve their mechanical properties. As is known, gaps between adjacent layers significantly reduce the quality of FFF-printed parts. This is especially true for parts with complex geometries, where weak interlayer properties, such as sharp corners and thin walls, can cause the part to fail under the applied load. The weak load-bearing capacity of the above-mentioned points of complex component geometries is one of the obstacles to the widespread use of printed components in industrial practice. In order to improve the mechanical and thermal characteristics of FFF-printed parts, designers incorporate reinforcing fibers, made of a different material quality than the polymer of the part (e.g., glass fiber, carbon fiber, basalt fiber, etc.), into the part during the printing process. The 3D printing of these so-called composite parts (or polymer composites) is time-consuming and expensive, since printing has to be interrupted to place these reinforcing fibers, as they have to be inserted between the printed layers with the help of a separate device (possibly by hand). Another disadvantage of current polymer composites is that the reinforcing fibers are fixed between the layers with adhesives, which further complicates the production of the composite and makes it more expensive, and is also an environmental burden.

### SUMMARY OF THE INVENTION

The inventors realized that polymer nano/microfibers with a maximum diameter of a few micrometers (or, as the case may be, a few nanometers in diameter) can also be used as reinforcing fibers during the FFF printing of polymer composites. Nano/microfibers are extremely long (“continuous”) relative to their diameter and have good thermal and mechanical properties. A nano/microfiber layer can be formed from the continuous fine fibers. The inventors discovered that nano/microfibers have good interfacial adhesion compared to the traditional (glass, carbon, basalt, etc.) fibers due to their high surface/volume ratio, and therefore improve adhesion between adjacent printing layers. In FFF-printed composite parts reinforced with polymer nano/microfibers, the nano/microfibers slow down and stop the propagation of cracks as well.

The inventors also recognized that there is currently no FFF method that integrates polymer nano/microfibers into the printed structures. In the past two decades, several attempts have been made to develop strategies for FFF printing of textile structures. However, the properties of printed textiles produced by current methods fall short of the parameters of traditional textiles. On the other hand, the production of such printed textile structures is expensive or requires advanced hardware, which prevents their widespread application.

The inventors also realized that with the proper design of a print head for filament 3D printers, self-reinforced composites (i.e., polymer layers made with reinforced nano/microfibers) can be created from the material of the polymer filament used for printing, even during printing. In this way, it is possible to produce the layers of the polymer composite and the reinforcing nano/microfibers, which fill the voids between the layers, and can be produced with the same print head, i.e., the fiber reinforcement of the composite can be integrated into the 3D printing process. Also, it is possible to shape and position the nano/microfiber layer in the same way as the filament layers of 3D printing, by moving the print head. In this way, one-step production of purely polymer composites is possible, which reduces production costs and process downtime, and less waste is generated.

Thus, one objective of the invention is to create a print head for a filament 3D printer that is free from the disadvantages of current other solutions, i.e., the printing and fiber reinforcement of polymer composites can be performed with the help of a single device during 3D printing. One objective of the invention is to create a 3D printer that includes such a print head. Another objective of the invention is also to provide a method during which a polymer composite can be produced in a single 3D printing process with a single device.

The operating principle of the print head in one embodiment of the invention is that there are one or more air outlet openings arranged axisymmetrically (i.e., symmetrically around an axis) around the outlet aperture of the print head, and these openings are directed towards a meeting zone on the longitudinal axis of the nozzle. Through these air outlet openings, a high-pressure, axisymmetric air flow can be delivered to the meeting zone and to the printing filament present there. The air stream carries with it the plastic filament, which has already been melted by the print head, during which the filament stretches, thereby creating continuous nano/microfibers. By suppressing the air flow, the print head can be used as usual for 3D printing, i.e., for creating filament layers. Note that a diameter of the typical filament fed to a 3d print head is 1.75 or 3 mm, and the extruded filament diameter is similar in size.

### BRIEF DESCRIPTION OF THE DRAWINGS

Further details of the invention will be explained with the help of drawing examples.

In the drawing, FIG. 1A is a schematic side sectional view of a possible embodiment of a print head according to the invention,

FIG. 1B is a schematic side sectional view of another possible embodiment of a print head according to the invention,

FIG. 2A is a schematic view of a first possible embodiment of a nozzle with air outlet openings according to the invention,

FIG. 2B is a schematic view of a second possible embodiment of a nozzle with air outlet openings according to the invention,

FIG. 2C is a schematic view of a third possible embodiment of a nozzle with air outlet openings according to the invention,

FIG. 3A is a schematic view depicting the closed position of the air deflector module of the printhead shown in FIG. 1B and illustrating the operation of the printhead in the closed position,

FIG. 3B is a schematic view depicting the open position of the air deflector module of the printhead shown in FIG. 1B and illustrating the operation of the printhead in the open position,

FIG. 4 is a schematic view illustrating the cross-section of the polymer composite produced with the print head according to one embodiment of the invention, and

FIG. 5 is a schematic view of an example of a filament 3D printer according to one embodiment of the invention.

### DETAILED DESCRIPTION OF THE INVENTION

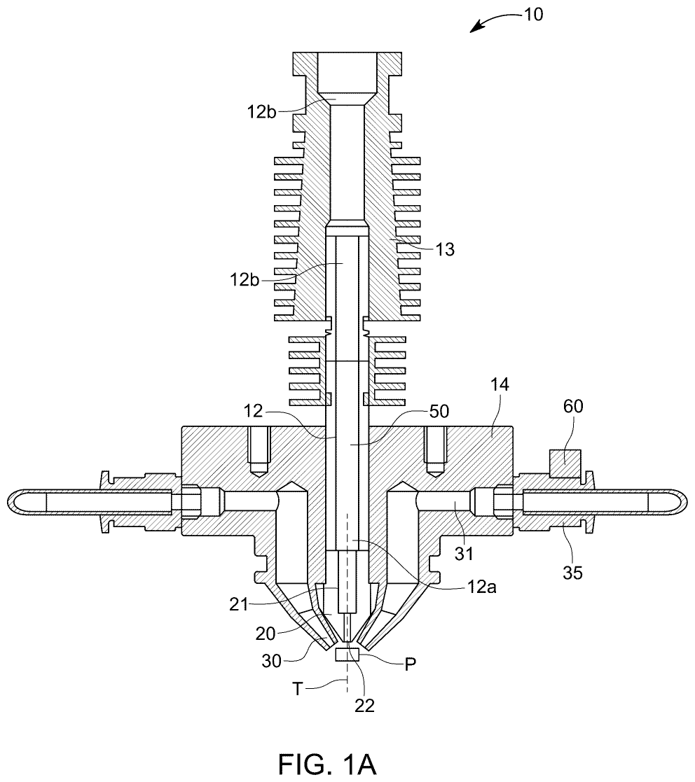

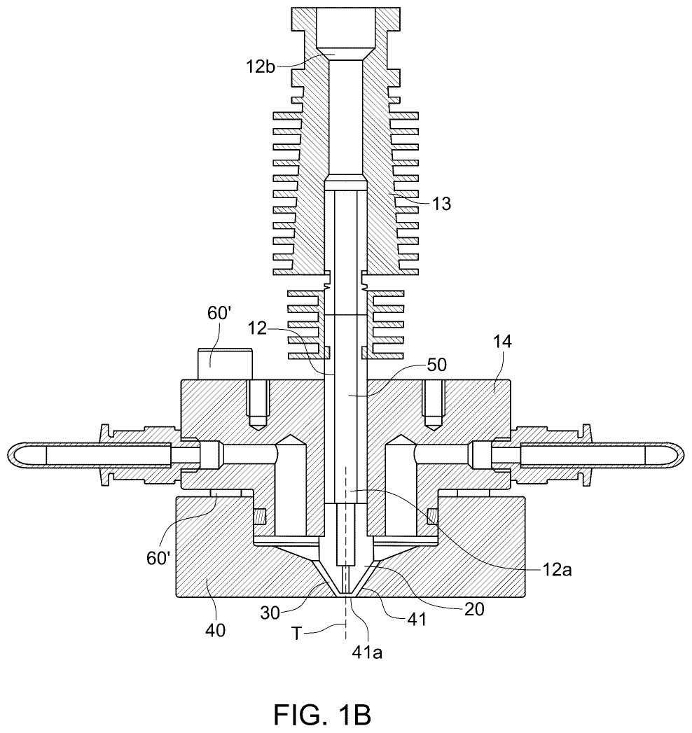

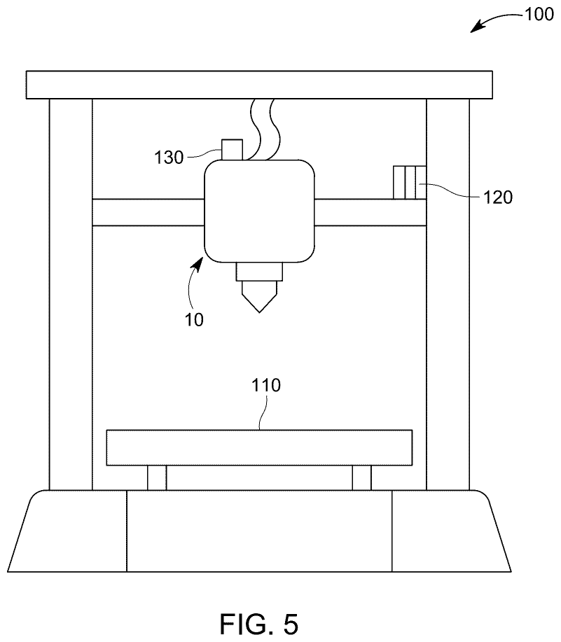

FIG. 1A shows a schematic side sectional view of a possible embodiment of a print head 10 according to one embodiment of the invention. The print head 10 uses a filament 50 for generating a printed part, i.e., for FFF 3D printers 100 as shown in FIG. 5. The filament 50 may include one or more of polymers, thermoplastic polymers, elastomers, additives, nanoparticles, etc. The print head 10 includes a channel 12 for guiding the polymer filament 50, a heating block 14 in contact with the channel 12, and a nozzle 20 connected to an outlet opening 12a of the channel 12. In the context of the present embodiment, the printer filament 50 is the filament typically used in 3D printers 100, which is typically spooled and made of a polymer or a thermoplastic polymer and has a diameter in the mm range. The printing filament 50 is pushed into the inner opening 12b of channel 12 by an extruder (not shown in the figures), as is known in the art. The printing filament 50 can be made of, for example, a bioplastic, such as polylactic acid (PLA), or an engineering plastic, such as polycarbonate, acrylonitrile-butadiene-styrene or polyamide. The channel 12 is made of a heat-resistant material, for example metal, a pipe open at both ends, which is preferably of a straight design, as can be seen in FIG. 1A. The internal cross-section of the channel 12 is expediently circular and its internal diameter is the same as or slightly larger than the diameter of the printing filaments 50.

The heating block 14 surrounds at least one section of the channel 12, that is, the channel 12 is preferably routed through the heating block 14. It should be noted that a design can also be imagined in which a part of the channel 12 is formed from the material of the heating block, i.e., in this case the channel 12 is a hole created in the heating block. The heating block 14 can be, for example, a heating block 14 commonly used in 3D printers 100, e.g., a heating block 14 equipped with an electric heating filament, which is used to heat the channel 12 and the nozzle 20, and to melt the printing filament 50 therein. The part of the channel 12 outside the heating block 14 is preferably surrounded by cooling fins 13 so that the printing filament 50 does not melt there and can be forced towards the nozzle 20 with the help of the extruder.

Like the channel 12, the nozzle 20 is made of a heat-resistant material, preferably metal, and is in direct contact with the heating block 14; for example, it is attached to the heating block 14 with threads, as can be seen in FIGS. 1A, 1B. The nozzle 20 has a longitudinal axis T and is provided with a through hole 21; one end of the hole 21 is connected to the outlet opening 12a of the channel 12, and the other end ends in an aperture 22. The diameter of the aperture 22 is preferably a few tenths of a millimeter, which means that the extruded filament has a diameter in the same range. In the preferred implementation shown in FIGS. 1A and 1B, the nozzle 20 has a conical shape that tapers in the direction of the aperture 22, thus the nozzle 20 can be precisely positioned during 3D printing. In other words, in this embodiment, the longitudinal axis T is the axis of symmetry of the nozzle 20 and axis T passes through the hole 21 and the aperture 22.

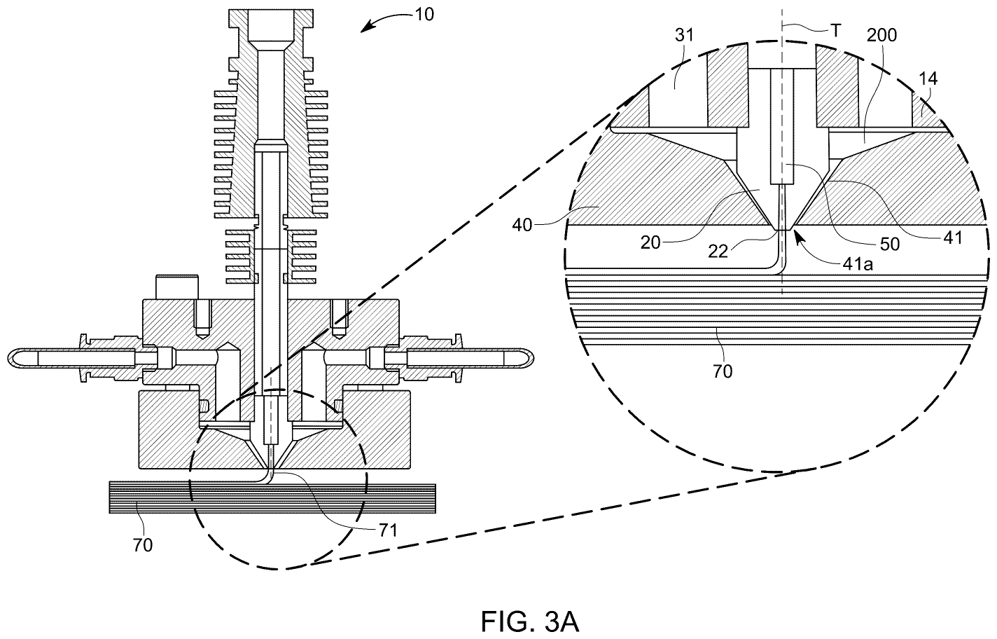

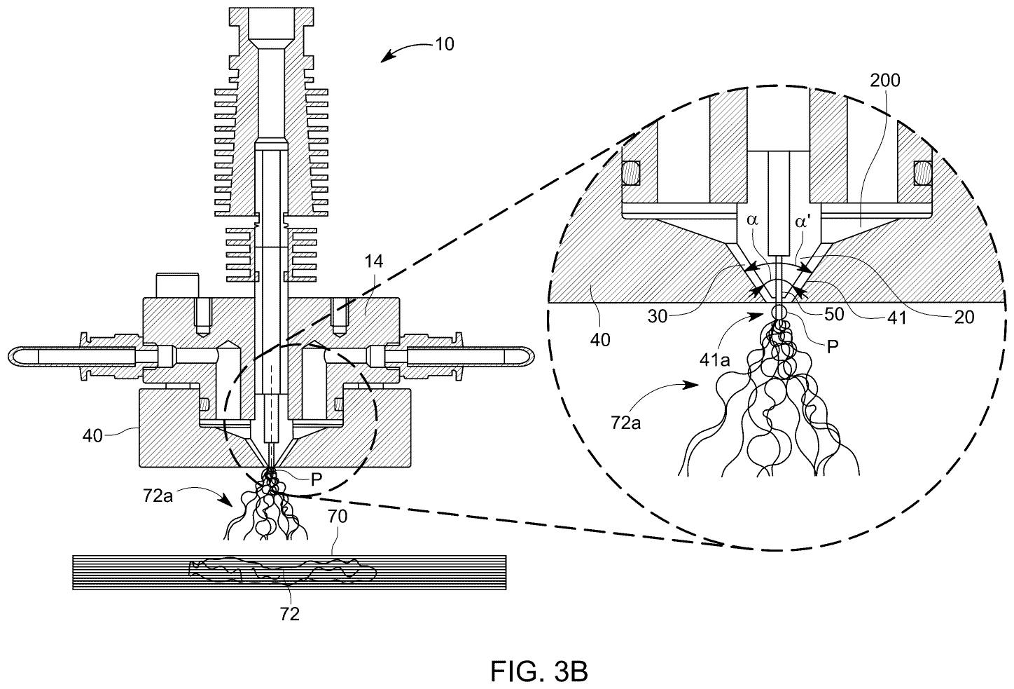

The print head 10 contains one or more air outlet openings 30 arranged axisymmetrically around the outlet aperture 22 of the nozzle 20 and directed towards a meeting zone P located on the longitudinal axis T of the nozzle 20. In other words, the one or more air outlet openings 30 are arranged in the vicinity of the aperture 22, around the longitudinal axis T of the nozzle 20, symmetrically relative to the longitudinal axis T. In the context of the present embodiment, the meeting zone P (see FIGS. 1A and 3B) is the small space located on the longitudinal axis T, outside the nozzle 20, below the aperture 22 and encircled by the one or more air outlet openings 30. In addition, the meeting zone P is positioned so that air flows from the one or more air outlet openings 30 and the extruded filament from hole 21 are directed. In one embodiment, the directions marked by the one or more vents 30 and the imaginary extension of the hole 21 intersect in the meeting zone P. A distance between the meeting zone P and the aperture 22 is preferably a few tenths or a few millimeters. Thus, the meeting zone P is defined by the aperture 22 and tips of the one or more air outlet openings 30.

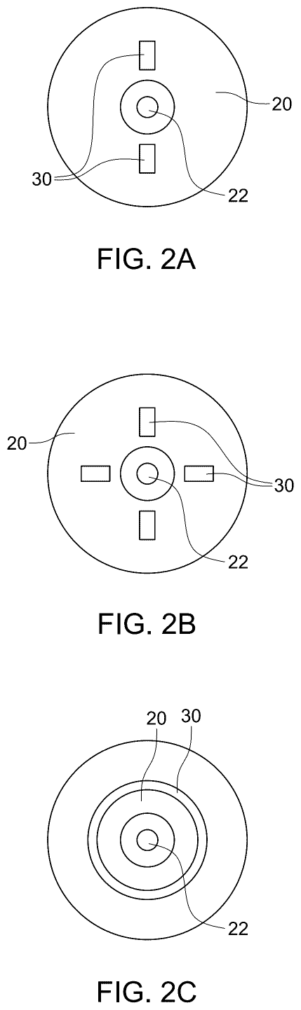

The air outlet openings 30 can be, in one application, an air deflector, with the help of which an air stream, preferably a high-pressure (minimum pressure of 0.1 bar) air stream, can be directed from the nozzle 20 to the meeting zone P. The air flow created by the air outlet opening 30 can be divided into a component perpendicular to the longitudinal axis T and a component parallel to the longitudinal axis T. The configurations shown in FIGS. 2A and 2B contain several air outlet openings 30 arranged symmetrically around the longitudinal axis T in such a way that the air outlet openings 30 located on opposite sides of the longitudinal axis T form pairs and thus, the perpendicular components of the air flows cancel each other. To the contrary, the parallel components of the air flows add to each other, creating an enhanced air stream along the longitudinal axis T, away from the nozzle 20. This enhanced parallel air stream is responsible for forcing the extruded filament to move faster than in traditional print head, which results in a thinner filament, the nano/microfiber discussed above. A line connecting the members of a pair of air outlet openings 30 passes through the longitudinal axis T, due to axial symmetry. FIG. 2A shows a single pair, while FIG. 2B shows two pairs of air outlet openings 30. Of course, in specific cases, configurations are also possible in which the air outlet openings 30 form more than two pairs. In a configuration shown in FIG. 2C, the print head 10 contains a single air outlet opening 30 formed symmetrically around the longitudinal axis T of the nozzle 20, i.e., concentric to the longitudinal axis T. Note that since one or more air outlet openings 30 are arranged axisymmetrically around the aperture 22, the shape of the air flow created by the air outlet openings 30 is also axisymmetric about the longitudinal axis T, i.e., the perpendicular components of the air streams cancel each other and the parallel components enhance each other. The air outlet opening 30 can be implemented, for example, as a hole created in the wall of the nozzle 20, or as separate units arranged axisymmetrically around the longitudinal axis T in the vicinity of the nozzle 20, as shown, for example, in FIG. 1A.

In the possible configuration shown in FIG. 1B, for example, the nozzle 20 is attached to the heating block 14, and the print head 10 further contains an air deflector module or air knife 40 that can be moved between a closed and an open position along the longitudinal axis T of the nozzle 20 relative to the heating block 14. A nest 41 for receiving the nozzle 20 is formed in the air deflector module 40, which nest 41 is provided with an opening 41a, which is configured to receive the aperture 22 of the nozzle 20. The opening 41a allows the aperture 22 of the nozzle 20, when placed in the nest 41, to remain free, i.e., open, so that the filament 50 can be extruded as desired. The nest 41 allows the nozzle 20 to move back and forth, so that the tip of the nozzle 20 may be positioned inside or outside the air deflector module 40. The size of the nest 41 can be adjusted by moving the air deflector 40 relative to the heating block 14.

The open position of the air deflector module 40 is illustrated in FIG. 3B, where the part of the print head 10 marked with a dashed circle has been enlarged for better illustration. In the open position, the air deflector module 40 and the heating block 14 together define an intermediate space 200, which is open to the opening 41a, and the nozzle 20 does not come into contact with the nest 41. This results in the formation of the nano/microfibers 72a (see FIG. 3B) instead of the traditional single extruded filament 71 (see FIG. 3A). Thus, the opening 41a is open in the open position of the air deflector module 40, and the opening 41a together with the outer wall of the nozzle 20 defines an annular air discharge opening 30.

The cross-section of the air outlet opening 30 can be increased or decreased by adjusting the distance between the nozzle 20 and the nest 41. The nozzle 20 and the nest 41 are preferably cone-shaped and the opening angles α of the cones are between 60 degrees and 140 degrees. The cones are configured in one embodiment so that their imaginary peaks fall on the longitudinal axis T, in the meeting zone P. Note that the opening angle α of the cone of the nozzle 20 is preferably smaller than or equal to the opening angle α′ of the cone of the nest 41. By moving the air deflector module 40 towards the heating block 14, the nozzle 20 can be brought into contact with the nest 41. The resulting closed position is illustrated in FIG. 3A. In this position, the opening 41a is closed by the nozzle 20, the diameter of the air outlet opening 30 is reduced to zero, so it is not possible to flow air through it. For this position, the print head acts as a traditional print head, i.e., it only generates an extruded filament 71 without reducing its diameter to generate nano/microfibers 72a, as shown in FIG. 3B.

In a possible configuration, the one or more air outlet openings 30 of the print head 10 are connected, by means of one or more air conveying lines 31, to one or more built-in compressor units 35 for producing an air flow directed towards the meeting zone P through the one or more air outlet openings 30, as illustrated in FIG. 1A. The compressor 35 can be a device suitable for the production of compressed air, operating on any known principle, with the help of which an air stream with a pressure of between 0.1 and 10 bar can be created at the one or more air outlet openings 30. The compressed air created by the compressor 35 reaches the one or more air outlet openings 30 with the help of one or more preferably heat-resistant air delivery lines 31. In a particularly advantageous configuration, the one or more air conveying lines 31 are routed through the heating block 14, whereby the compressed air heats up before it reaches the one or more air outlet openings 30. The air leaving the air outlet openings 30 can thus be heated to a high temperature, even exceeding 200 degrees Celsius, typically between 200 and 300 degrees Celsius. One skilled in the art would understand that the temperature would be controlled so that the filament material is not degraded.

In another application, the print head 10 contains a control unit 60 for controlling the air flow flowing through one or more air outlet openings 30, as also shown in FIG. 1A. The control unit 60 can be, for example, the controller of the compressor 35, with the help of which the compressor 35 can be switched on and off or its power can be changed. In another possible application, the control unit 60 is a valve inserted in the air duct 31 (not shown in the figures), which can be used to change the cross-section of the air duct 31, and the air flow can be stopped if necessary. In the embodiment shown in FIG. 1B, which includes the air deflector module 40, the control unit 60 can also be designed as a moving device 60′ for moving the air deflector module 40 between closed and open positions. With the help of the moving device 60′, the distance between the nozzle 20 and the nest 41 can be changed, and thus the cross-section of the air outlet opening 30 can be changed to control the flow of the air stream, for example, from no air stream to a desired high pressure air stream.

One embodiment of the invention is directed to a filament 3D printer 100, which includes a print head 10 according to the embodiments discussed above. One possible implementation of the 3D printer 100 is shown in FIG. 5. The 3D printer 100 includes the usual elements, such as a print bed 110, a device 120 for moving the print head 10, and an extruder 130 (for example, a stepper motor) for feeding the printing filament 50, etc., as is known in the art.

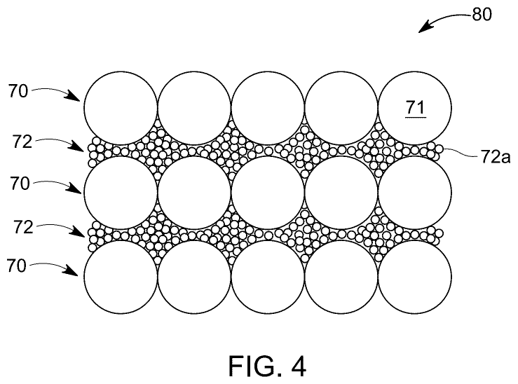

According to another embodiment of the invention, a method for producing a 3D printed polymer composite 80 (see FIG. 4) using the print head 10 is now discussed. Note that in the context of the present embodiment, the polymer composite 80 means a structure made of polymer layers with different physical properties, produced by 3D printing.

During the printing process, printing filaments 50 made of a polymer are passed through the channel 12 of the printing head 10, e.g., a roller extruder commonly used in filament 3D printers 100. With the help of the heating block 14, the printing filaments 50 in the channels 12 are heated above the melting temperature of the polymer forming the printing filaments 50 and, and thus they are melted. In one application, the heating block 14 is controlled to make sure that the temperature does not reach the decomposition temperature of the printing filaments 50. In a particularly advantageous example, the part above the inlet opening 12b of the channel 12 is preferably surrounded by a cooling fin 13, which, by dissipating the heat, ensures that the printing filament 50 does not melt there and thus it can be more easily forced towards the heating block 14.

In the next step of the method according to the embodiment, the melted printing filament 50 is pressed through the hole 21 of the nozzle 20 and finally through the aperture 22, creating extruded filaments 71, as shown in FIG. 3A. From the printing filaments 50 melted and pressed through the aperture 22 of the nozzle 20, a standard filament layer 70 is created on the print bed 110 by positioning the print head, as can be seen in FIG. 3A. The shape of the filament layers 70 can be determined by the appropriate positioning (movement) of the print head 10, as is known to a person skilled in 3D printing. Note that no air is flown through the air outlet openings 30 during the formation of the filament layer 70 as the outlet openings 30 are closed in FIG. 3A.

In the next step of the process, a nano/microfiber layer 72 formed by polymer nano/microfibers 72a is applied onto the filament layer 70, as shown in FIGS. 3B and 4. In the context of the present embodiment, the nano/microfibers 72a mean fibers made of polymer with a diameter in the order of nanometers or micrometers, but with a length that may reach several centimeters. The nano/microfibers 72a have a diameter smaller than a diameter of the extruded filaments 71 because of the presence of the air streams discussed above. In one application, by modulating the air stream speed with the controller 60, it is possible to change, during the printing process, the diameter of the nano/microfibers 72a as desired. FIG. 3B shows a possible production of the nano/microfibers 72a with the method according to the invention and print head 10. Note that during the creation of the filament layers 70, the nozzle 20 of the print head 10 is located essentially directly above the layer 70, i.e., only a few tenths of a millimeter, or perhaps a few millimeters away from it.

Therefore, after creating the filament layer 70, the distance between the print head 10 and the print bed 110 is increased to create the nano/microfibers 72a and implicitly the microfiber layer 72. In other words, a distance between the print head 10 or nozzle 20 and the composite part, for generating the extruded filament 71 is smaller than a distance between the print head 10 or nozzle 20 and the composite part. To create the layer 70, the melted printing filament 50 is pressed through the aperture of the nozzle 20, and thus, the filament 50 is moved along the longitudinal axis T of the nozzle 20 to the melting zone P. Meanwhile, to create the layer 72, a high-pressure, i.e., at least 0.1 bar, axisymmetric air flow is directed towards the meeting zone P through the air outlet opening 30, which is arranged axisymmetrically around the outlet aperture 22 of the nozzle 20. The high-pressure air stream takes with it the end of the melted printing filament 50, or a part of it, which causes the end of the printing filament 50 to elongate, and the diameter of the formed filament part 72a decreases to the order of micrometers or, as the case may be, to nanometers. Note that the axisymmetric airflow simultaneously creates multiple nano/microfibers 72a from the printing filament 50, as can be seen in FIG. 3B.

The resulting nano/microfibers 72a are drawn in by the air stream and spread under the nozzle 20 in the direction of the air stream. The nano/microfibers 72a in the molten state adhere to each other and arrange themselves in a structure similar to that of a non-woven fabric. With the implementation of the one or more nozzles 20 and changing the shape of the air flow, the “scatter pattern” of the nano/microfibers 72a can be adjusted. In the implementation shown in FIG. 3B, for example, with the help of the air deflector module 40, a cone-shaped airflow is created, the apex of which is located in the meeting zone P. The opening angle of the cone cover is preferably chosen to be between 60 degrees and 140 degrees. By reducing the opening angle of the cone-shaped airflow, the nano/microfibers 72a can be focused on a smaller area of the layer 70.

In the next step, by properly positioning the print head 10, the nano/microfibers 72a are taken onto the filament layer 70, creating a microfiber layer 72, as illustrated in FIG. 4. The layer 72 may cover the entire surface of the layer 70, or if appropriate, only a part of it. Since the nano/microfibers 72a are essentially in a melted or soft state after their production, the microfiber layer 72 practically “melts on” or “sticks to” the filament layer 70, and thus, it is not necessary to use an adhesive between the individual layers 70 and 72. Then, another layer of filament 70 can be applied to the microfiber layer 72 by stopping the air flow and moving the print head 10 closer to the layer 72. If appropriate, several layers 70 and 72 can be layered on top of each other as shown above, according to the structure of the polymer composite 80. The schematic diagram of the resulting polymer 80 composite is shown in FIG. 4.

In one application, the diameter of the nano/microfibers 72a is reduced by increasing the distance between the print head 10 and the print bed 110, and during the creation of the microfiber layer 72, the distance between the print head 10 and the print bed 110 is chosen to be between 5 mm and 500 mm.

In another possible implementation, the diameter of the nano/microfibers 72a is changed with the parameters of the method used in the invention. The diameter of the nano/microfibers 72a is reduced, for example, if the pressure of the air stream is increased, and the pressure of the air stream is chosen to be between 0.1 and 10 bar. In another implementation, the diameter of the nano/microfibers 72a is reduced by reducing the aperture 22 of the nozzle 20, and the aperture 22 of the nozzle 20 is preferably chosen to be between 0.1 and 0.5 mm. In other words, to produce smaller diameter nano/microfibers 72a, it is possible to increase the pressure of the air stream and/or decrease the diameter of the aperture 22 and/or increase the distance between the nozzle 20 of the print head 10 and the print bed 110.

In yet another implementation, the thermal stability of the nano/microfibers 72a is increased by increasing the temperature of the air stream. In the context of the present description, thermal stability refers to the property of the nano/microfibers 72a to withstand heat and maintain their strength, toughness or flexibility at a given temperature, as is known to those skilled in the art. In a preferred case, the temperature of the air stream is chosen to be between room temperature and the decomposition temperature of the material of the polymer printing filament 50.

In the following, some specific examples illustrate the relationships between the parameters of the method according to the embodiment and the diameter of the nano/microfibers 72a.

### Example 1

In this case, the nano/microfibers 72a were created with the configuration of the print head 10 shown in FIGS. 1B and 3B, which includes air deflector modules 40. To produce the nano/microfibers 72a, the inventors used printing filaments 50 made of polylactic acid (PLA), which were fed into the printing heads 10 at a speed of 1 mm/min. The diameter of the aperture 22 of the nozzle 20 was 0.2 mm. The distance between the nozzle 20 of the print head 10 and the print bed 110 was set to 100 mm for generating the nano/microfibers 72a. The table below shows the average diameter of the resulting nano/microfibers 72a as a function of the opening angle of the cone-shaped nest 41 of the air deflector module 40 and the pressure of the air stream. As can be seen, thinner nano/microfibers 72a can be created by increasing the pressure and the opening angle of the air stream.

| | 120 degree opening angle: | 70 degree opening angle: |
|---|---|---|
| Air pressure (bar) | Average thread diameter | Average thread diameter |
| 1 | 1.47 ± 0.16 μm | 1.72 ± 0.17 μm |
| 1.5 | 1.10 ± 0.16 μm | 1.23 ± 0.18 μm |
| 2 | 0.98 ± 0.14 μm | 1.05 ± 0.17 μm |

### Example 2

In this example, the inventors also used printing filaments 50 made of polylactic acid (PLA), which were also fed into the printing head 10 at a speed of 1 mm/min, but the diameter of the aperture 22 of the nozzle 20 was chosen to be 0.4 mm. The opening angle of the cone-shaped nest 41 of the air deflector module 40 was 120 degrees, and the pressure of the air flow was 1.5 bar. The table below shows the average diameter of the resulting nano/microfibers 72a as a function of the distance between the nozzle 20 and the print bed 110. For a greater distance between the nozzle 20 and the print bed 110, the air stream can stretch the nano/microfibers 72a thinner. Note that no traditional print head can generate microfibers 72a having the dimensions noted below or any type of nanofibers 72a.

| Nozzle-print bed distance (mm) | Average fiber diameter |
|---|---|
| 50 | 2.75 ± 0.19 μm |
| 100 | 1.57 ± 0.17 μm |
| 150 | 1.17 ± 0.17 μm |

### Example 3

In this case, the distance between the nozzle 20 and the print bed 110 was set to 100 mm for generating the nano/microfibers 72a, and the air flow pressure was set to 1 bar. The table below shows the average diameter of the resulting nano/microfibers 72a as a function of the opening angle of the cone-shaped nest 41 of the air deflector module 40 and the diameter of the aperture 22.

| Aperture | 120 degree opening angle | 70 degree opening angle |
|---|---|---|
| diameter (mm) | Average fiber diameter | Average fiber diameter |
| 0.5 | 3.08 ± 0.35 μm | 3.44 ± 0.31 μm |
| 0.4 | 2.49 ± 0.38 μm | 2.73 ± 0.29 μm |
| 0.2 | 1.47 ± 0.16 μm | 1.72 ± 0.17 μm |

It is noted that one skilled in the art can imagine other alternative solutions for the designs presented here, which, however, still fall within the scope of protection defined by the claims.

1. A printhead for a filament 3D printer, the printhead comprising:
a channel for guiding a polymer filament through an outlet opening;
a heating block in contact with the outlet opening of the channel and configured to heat the polymer filament;
a nozzle having an outlet aperture, wherein the nozzle is connected to the outlet opening of the channel so that the polymer filament passes through the outlet aperture, and the outlet aperture of the nozzle is arranged axisymmetrically around the nozzle and located on the longitudinal axis (T) of the nozzle; and
one or more air outlet openings arranged axisymmetrically around the nozzle and directed towards a meeting zone (P) defined by tips of the air outlet openings, and the outlet aperture of the nozzle.

2. The print head according to claim 1, wherein the one or more air outlet openings are configured to provide pressured air toward the polymer filament, at the meeting zone (P), when exiting the outlet aperture, to extend the polymer filament while reducing a diameter of the polymer filament.

3. The print head according to claim 1, wherein the print head contains a single annular air outlet opening symmetrically formed around the longitudinal axis (T) of the nozzle.

4. The print head according to claim 1, further comprising:
one or more air conveying lines connected to the one or more air outlet openings; and
a compressor unit configured to produce an air flow through the one or more air outlet openings-towards the meeting zone (P).

5. The print head according to claim 4, wherein the one or more air conveying lines are routed through the heating block.

6. The print head according to claim 1, further comprising:
a control unit configured to turn on an air flow through the air outlet openings and increase a distance between the aperture of the nozzle and a composite part when forming nano or microfibers, and to turn off the air flow and to decrease the distance between the aperture of the nozzle and the composite part when forming extruded filaments, wherein the extruded filaments have a diameter larger than the nano or microfibers.

7. The print head according to claim 1, wherein the nozzle is attached to the heating block and the print head contains an air deflector module configured to be moved between closed and open positions along the longitudinal axis (T) of the nozzle-relative to the heating block, to adjust air flows exiting the one or more air outlet openings.

8. The print head according to claim 7, wherein the air deflector module has a nest
configured to receive the nozzle, the nest has an opening corresponding to the aperture of the nozzle, which opening is open in the open position of the air deflector module so that the air flows are present, and is closed by the nozzle in the closed position of the air deflector module so that the air flows are suppressed.

9. The print head according to claim 8, wherein the one or more air outlet openings are defined by the nozzle and the opening of the open air deflector module.

10. The print head according to claim 6, wherein the control unit is configured to move the air deflector module-between a closed position and an open position.

11. The print head according to claim 8, wherein the nozzle and the nest are shaped as cones and opening angles of the cones are between 60 degrees and 140 degrees.

12. A filament drawing 3D printer comprising:
a print bed configured to support a 3D printed polymer composite having a filament layer and a microfiber layer; and
a print head configured to print the 3D printed polymer composite,
wherein the print head includes,
a nozzle having an outlet aperture, wherein the nozzle is configured to pass a polymer filament through the outlet aperture to form the filament layer, and
one or more air outlet openings directed towards a meeting zone, which is defined by tips of the air outlet openings and the outlet aperture of the nozzle, wherein the one or more air outlet openings are configured to provide pressurized air to the meeting zone (P) to form the nano/microfiber layer.

13. The 3D printer according to claim 12, wherein the outlet aperture is arranged axisymmetrically around the nozzle.

14. The 3D printer according to claim 12, further comprising:
a channel for guiding the polymer filament through an outlet opening; and
a heating block in contact with the outlet opening of the channel and configured to heat the polymer filament.

15. A method for producing a 3D printed polymer composite by using a print head, the method comprising:
passing a printing filament through a channel of the print head, while the printing filament is heated and melted by the print head using a heating block;
pressing the melted printing filament through an aperture of a nozzle of the print head;
forming a filament layer on a print bed from the melted printing filament pressed through the aperture of the nozzle by positioning the print head above the print bed; and
forming a microfiber layer onto the filament layer-by producing polymer nano/microfibers in such a way that the printing filament, after being pressed through the aperture of the nozzle, is moved along the longitudinal axis (T) of the nozzle to a meeting zone (P), while directing a high-pressure air stream towards the meeting zone (P) through one or more air outlet openings arranged symmetrically around the outlet aperture of the nozzle, and then the nano/microfibers created in this way are deposited on the filament layer.

16. The method according to claim 15, wherein, after the creation of the filament layer, a distance between the print head and the print bed is increased to create the microfiber layer.

17. The method according to claim 15, wherein a diameter of the nano/microfibers is reduced by increasing the distance between the print head and the print bed.

18. The method according to claim 15, wherein a diameter of the nano/microfibers is reduced by increasing a pressure of the air stream.

19. The method according to claim 15, wherein a diameter of the nano/microfibers is reduced by reducing the aperture of the nozzle, and the aperture of the nozzle is between 0.1 and 0.5 mm.

20. The method according to claim 15, wherein a cone-shaped air flow is created with the one or more air outlet openings, and a tip of a cone defined by the one or more air outlet openings is located in the meeting zone (P), and the opening angle of the cone is between 60 degrees and 140 degrees.
